(19) United States
(12) Patent Application Publication
(10) Pub. No.: US 2013/0251356 A1
(43) Pub. Date: Sep. 26, 2013

(54) IMAGING DEVICE

(71) Applicant: PANASONIC CORPORATION, Osaka (JP)

(72) Inventor: Ryuji NAKAMURA, Osaka (JP)

(73) Assignee: Panasonic Corporation, Osaka (JP)

(21) Appl. No.: 13/789,689

(22) Filed: Mar. 8, 2013

(30) Foreign Application Priority Data
Mar. 23, 2012 (JP) 2012-066611

(51) Int. Cl. G02B 27/64

(52) U.S. Cl. CPC G02B 27/646
USPC 396/55

(57) ABSTRACT

An imaging device with which the accuracy of blur correction is improved. The imaging device comprises an imaging component, a transformer circuit, a control circuit, a blur detecting sensor, a memory, and a blur correction controller. The imaging component captures a subject and outputs image data. The transformer circuit transforms a power supply voltage. The control circuit controls the transformer circuit. The blur detecting sensor detects blur. The memory stores information related to a specific frequency range. The blur correction controller performs first blur correction control based on the output of the blur detecting sensor when the frequency of the transformer circuit is outside the specific frequency range while the control circuit is performing control. The blur correction controller performs second blur correction control different from the first blur correction control, when the frequency of the transformer circuit is within the specific frequency range.

### CROSS-REFERENCE TO RELATED APPLICATIONS

This application claims priority under 35 U.S.C. §119 to Japanese Patent Application No. 2012-066611 filed on Mar. 23, 2012. The entire disclosure of Japanese Patent Application No. 2012-066611 is hereby incorporated herein by reference.

### BACKGROUND

1. Field of the Invention

The present invention relates to an imaging device equipped with a flash and an image stabilization function.

2. Description of the Related Art

A conventional imaging device comprises an angular velocity sensor for detecting blur, and an image stabilization function. The image stabilization function reduces blur caused by camera blur or the like and occurring in the captured image data. With this type of imaging device, there is a known configuration in which computation of the amount of blur is not performed, on the basis of the detection result of the angular velocity sensor, during charging when a flash is used (when a booster circuit is used) (see Japanese Laid-Open Patent Application 2005-128224, for example).

The reason for this is that the output of the sensor is unstable, being affected by noise from the booster circuit during use of the booster circuit, so there is the risk of a decrease in accuracy in the detection of blur. With a conventional imaging device, during the charging of the flash, the blur detection operation and the flash charging operation are carried out alternately, so that blur detection can be performed even when the flash is being charged.

### SUMMARY

A problem encountered with a conventional imaging device was that since charging and blur detection are carried out alternately, it is fundamentally impossible for both to be carried out at the same time, and this results in lower efficiency.

The present invention was conceived in light of the above problem, and it is an object thereof to provide an imaging device with which accuracy can be improved in blur correction during the charging of a flash.

The imaging device disclosed herein comprises an imaging component, a transformer circuit, a control circuit, a blur detecting sensor, a memory, and a blur correction controller. The imaging component captures a subject and outputs image data. The transformer circuit is for transforming a power supply voltage. The control circuit controls the transformer circuit. The blur detecting sensor detects blur in the image data. The memory stores information related to a specific frequency range. The blur correction controller performs first blur correction control on the basis of the output of the blur detecting sensor when the frequency of the transformer circuit is outside the specific frequency range while the control circuit is performing control. The blur correction controller performs second blur correction control that is different from the first blur correction control when the frequency of the transformer circuit is within the specific frequency range.

The present invention provides an imaging device with which accuracy can be improved in blur correction during the charging of a flash.

### BRIEF DESCRIPTION OF DRAWINGS

FIG. 1 is a diagram of the configuration of the front face of a digital camera 100 pertaining to Embodiment 1;

FIG. 2 is a diagram of the configuration of the rear face of the digital camera 100 pertaining to Embodiment 1;

FIG. 3 is a diagram of the electrical configuration of the digital camera 100 pertaining to Embodiment 1;

FIG. 4 is a flowchart of the processing in imaging mode pertaining to Embodiment 1;

FIG. 5 is a flowchart of the flash charging operation pertaining to Embodiment 1;

FIG. 6 is a diagram illustrating battery power supply voltage and the range over which angular velocity sensor coring processing is performed in Embodiment 1;

FIG. 7 is a flowchart of still picture capture processing pertaining to Embodiment 1; and

FIG. 8 is a diagram illustrating the setting of the range over which angular velocity sensor coring processing is performed in another embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### Embodiment 1

With the digital camera 100 of Embodiment 1, in the charging of the flash of the digital camera 100, control that is different from usual is performed by the blur correction controller when the power supply voltage of the battery is within a specific voltage range.

### 1. Configuration

The configuration of the digital camera 100 will be described through reference to the drawings.

### 1-1. Configuration of Digital Camera 100

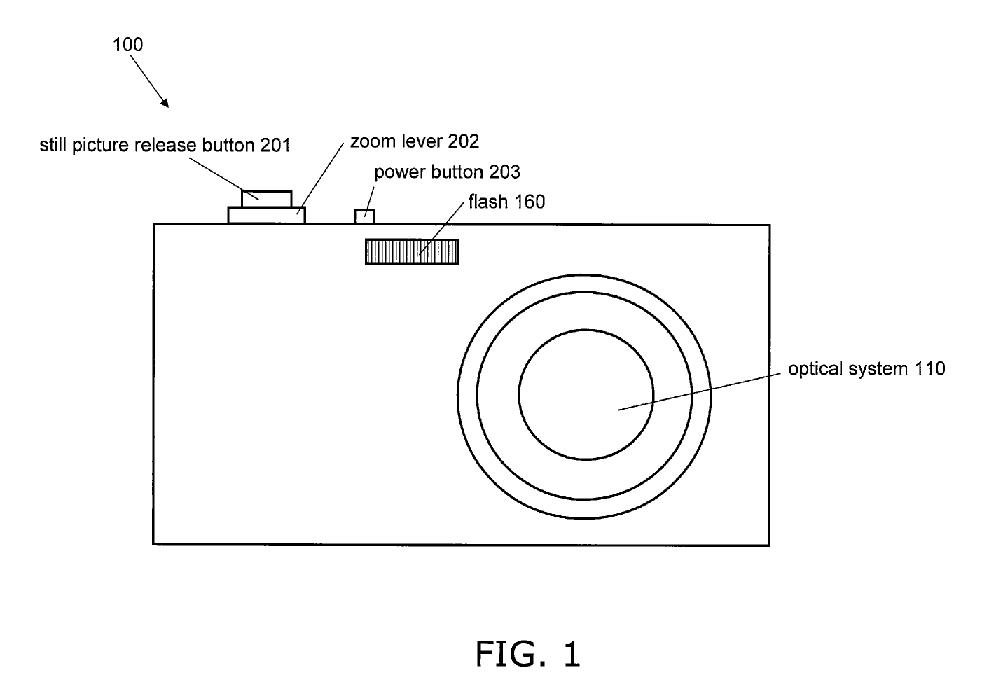

FIG. 1 is a diagram of the configuration of the front face of the digital camera 100. The digital camera 100 comprises on its front face a lens barrel that contains an optical system 110, and a flash 160 and so forth. The digital camera 100 comprises on its top face interface components consisting of a shutter button 201, a zoom lever 202, a camera ON/OFF switch 203, and so on.

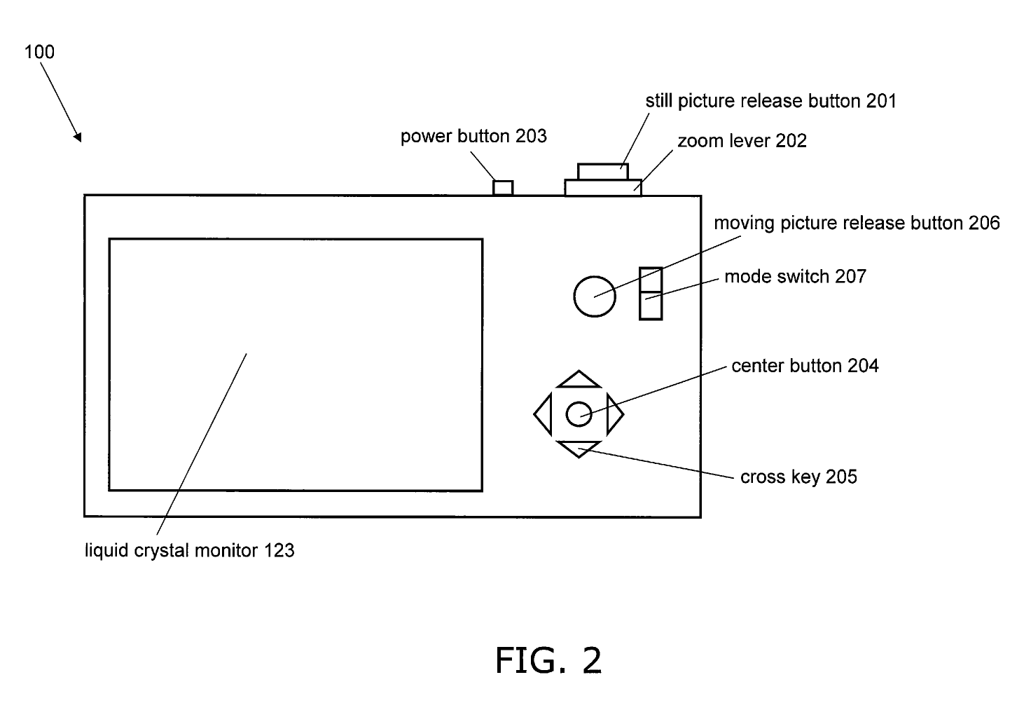

FIG. 2 is a diagram of the configuration of the rear face of the digital camera 100. The digital camera 100 comprises a liquid crystal monitor 123, a menu button 204, a cursor button 205, a moving picture release button 206, a mode switch 207, and other such interface components.

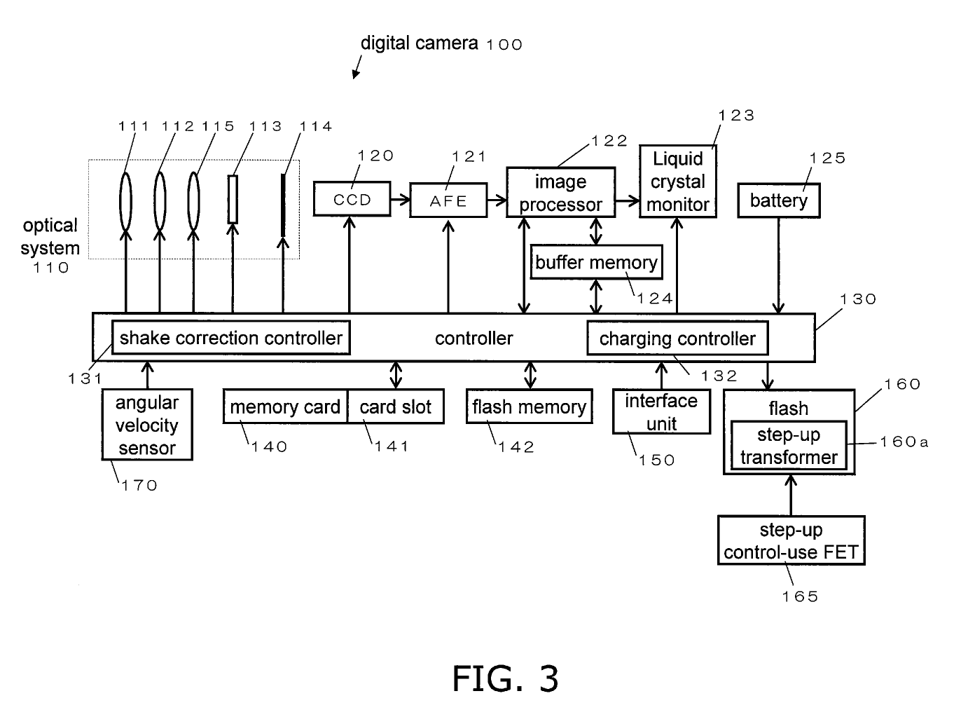

FIG. 3 is a diagram of the electrical configuration of the digital camera 100. The digital camera 100 captures a subject image formed via the optical system 110, with a CCD image sensor 120. The CCD image sensor 120 produces image data on the basis of the captured subject image. The image data thus captured undergoes various processing by an AFE (analog front end) 121 and an image processor 122. The image data thus produced is recorded to a recording medium. Recording media include a flash memory 142, a memory card 140, etc. In this embodiment, an example will be described in which the memory card 140 is used as a recording medium. The image data recorded to the memory card 140 is displayed on the liquid crystal monitor 123 according to operation of an interface unit 150 by the user. The various components shown in FIGS. 1 to 3 will be described in detail below.

The optical system 110 is constituted by a focus lens 111, a zoom lens 112, an aperture 113, a shutter 114, and so on. The various lenses that make up the optical system 110 can be constituted by any number of lenses or by any number of groups of lenses.

The focus lens 111 is used to adjust the focal state of the subject. The zoom lens 112 is used to adjust the field angle of the subject. The aperture 113 is used to adjust the amount of light that is incident on the CCD image sensor 120. The shutter 114 is used to adjust the exposure time for light incident on the CCD image sensor 120. An OIS lens 115 is able to move according to the angular velocity detected by an angular velocity sensor 170 (an example of a blur detecting sensor). Consequently, the OIS lens 115 corrects the amount of blur of the digital camera 100. The focus lens 111, the zoom lens 112, the aperture 113, the shutter 114, and the OIS lens 115 are each driven by a DC motor, a stepping motor, or another such drive unit, according to a control signal issued from the controller 130.

The CCD image sensor 120 captures a subject image formed by the optical system 110, and thereby produces image data. The CCD image sensor 120 produces a new frame of image data at regular time intervals when the digital camera 100 is in imaging mode. The CCD image sensor 120 is an example of an imaging component.

The AFE 121 subjects the image data read from the CCD image sensor 120 to noise suppression by correlated double sampling, amplification to the input range width of an A/D converter by analog gain controller, and A/D conversion by A/D converter. The AFE 121 then outputs the image data to the image processor 122.

The image processor 122 subjects the image data outputted from the AFE 121 to various kinds of processing. Examples of the various processing include smear correction, white balance correction, gamma correction, YC conversion processing, electronic zoom processing, compression processing, and expansion processing. The various processing is not, however, limited to what is listed here. The image processing unit 122 stores the image information that has undergone the various processing in a buffer memory 124. The image processor 122 may be a hard-wired electronic circuit, or may instead be a microprocessor that uses a program, etc. Also, the image processor 122 may be constituted by a single semiconductor chip along with the controller 130.

The liquid crystal monitor 123 is provided to the rear face of the digital camera 100. The liquid crystal monitor 123 displays images on the basis of image data processed by the image processor 122. The images displayed on the liquid crystal monitor 123 include through-images and/or recorded images. Through-images are displayed on the liquid crystal monitor 123 by having the CCD image sensor 120 continuously output to the liquid crystal monitor 123 a new frame of image data at regular time intervals. Usually, when the digital camera 100 is in imaging mode, the image processor 122 produces a through-image on the basis of image data produced by the CCD image sensor 120. The user can capture images while checking the composition of the subject by referring to the through-image displayed on the liquid crystal monitor 123. A recorded image is an image obtained by reducing the resolution of high-resolution image data recorded to the memory card 140, for display on the liquid crystal monitor 123, when the digital camera 100 is in imaging mode. The high-resolution image data recorded to the memory card 140 is produced by the image processor 122 on the basis of the image data produced by the CCD image sensor 120 after the user has operated the release lever.

A battery 125 supplies power to the various components and operates as a power supply. The power supply lines to the various components are not shown in the drawings.

The controller 130 controls the overall operation of the entire digital camera 100. The controller 130 records to the memory card 140 the image data that has been processed by the image processor 122 and the stored in the buffer memory 124. The controller 130 is constituted by a ROM that stores a program, a CPU that executes the program and thereby subjects various kinds of information to processing, and so forth. The ROM stores programs related to file control, autofocus control (AF control), auto exposure control (AE control), blur correction control (OIS control), light emission control of the flash 160, and so forth. The ROM also stores a program for the overall control of the entire digital camera 100. The controller 130 acquires a blur signal from the angular velocity sensor 170, and controls the OIS lens 115. Specifically, the controller 130 operates as a blur correction controller 131. The controller 130 also controls the charging of the flash 160. Specifically, the controller 130 also operates as a charging controller 132 (an example of a control circuit).

The blur correction controller 131 acquires an angular velocity value from the angular velocity sensor 170. This angular velocity value is used as a blur signal. The blur correction controller 131 also corrects blur by driving the OIS lens according to the acquired angular velocity value.

The charging controller 132 monitors the charging state of the flash 160, and performs charging when the remaining charge is low. The charging controller 132 is also able to acquire the power supply voltage of the battery 125.

The controller 130 may be a hard-wired electronic circuit, but may instead be a microcomputer or the like. Also, the controller 130 may be constituted by a single semiconductor chip along with the image processor 122. Also, the ROM need not be configured internally to the controller 130, and may instead be constituted externally to the controller 130.

The buffer memory 124 is a memory unit that functions as a working memory for the image processing unit 122 and/or the controller 130. The buffer memory 124 is a DRAM (dynamic random access memory) or the like. The flash memory 142 also functions as an internal memory for recording image data and digital camera 100 setting information, etc.

A card slot 141 is a connection means that allows the memory card 140 to be removed. The card slot 141 allows the memory card 140 to be electrically and mechanically connected. The card slot 141 may also have the function of controlling the memory card 140.

The memory card 140 is an external memory internally comprising a recorder such as a flash memory. The memory card 140 allows the recording of data such as a detailed history log or image data processed by the image processor 122.

The interface unit 150 refers collectively to control buttons, control dials, and so forth provided to the exterior of the digital camera 100, which are operated by the user. For example, as shown in FIGS. 1 and 2, the shutter button 201, the moving picture release button 206, the zoom lever 202, the camera ON/OFF switch 203, the menu button 204, the cursor button 205, the mode switch 207, and so forth correspond to the interface unit 150. The manipulation component 150 sends signals corresponding to operational commands to the controller 130 when operated by the user.

The shutter button 201 is a two-stage push button that can be pushed half-way down or all the way down. When the shutter button 201 is pressed half-way down by the user, the controller 130 executes AF (auto focus) control or AE (auto exposure) control, and decides on the imaging conditions. When the shutter button 201 is then pressed all the way down by the user, the controller 130 performs imaging processing. The controller 130 records image data captured at the point when the button was pressed all the way down as a still picture to the memory card 140, etc. Hereinafter, the phrase “the shutter button 201 is pressed” shall mean that it is pressed all the way down.

The moving picture release button 206 is a push button that is used to direct the start and end of moving picture recording. When the moving picture release button 206 is pressed by the user, the controller 130 successively records image data produced by the image processor 122 as a moving picture to the memory card 140, etc., on the basis of the image data produced by the CCD image sensor 120. The recording of the moving picture ends when the moving picture release button 206 is pressed again.

The zoom lever 202 is a lever that automatically returns to its center position and is used to adjust the field angle between the wide angle end and the telephoto end. When the zoom lever 202 is operated by the user, a signal is sent to the controller 130 directing it to drive the zoom lens 112. Specifically, when the zoom lever 202 is operated to the wide angle end side, the controller 130 drives the zoom lens 112 so that the subject is captured at a wide angle. Similarly, when the zoom lever 202 is operated to the telephoto end side, the controller 130 drives the zoom lens 112 so that the subject is captured in telephoto.

The camera ON/OFF switch 203 is a push button operated by the user to supply power to the various components of the digital camera 100. When the camera ON/OFF switch 203 is pressed by the user while the power is off, the controller 130 supplies power to the components that make up the digital camera 100, which actuates these components. When the camera ON/OFF switch 203 is pressed by the user while the power is on, the controller 130 halts the supply of power to the components.

The menu button 204 is a push button. When the digital camera 100 is in imaging mode or reproduction mode, and the menu button 204 is pressed by the user, the controller 130 displays a menu screen on the liquid crystal monitor 123. The menu screen is used to set various conditions for imaging and reproduction. The information set on the menu screen is recorded to the flash memory 142. When the menu button 204 is pressed after various condition setting categories have been selected, this button also functions as an enter button.

The cursor button 205 is a push button provided in the up, down, left, and right directions. The user presses the cursor button 205 in one direction to select the various condition categories displayed on the liquid crystal monitor 123.

The mode switch 207 is a push button provided in the up and down directions. The user presses the mode switch 207 in one direction to switch the state of the digital camera 100 to imaging mode or reproduction mode.

The flash 160 includes a booster transformer 160a for charging a capacitor by raising the power supply voltage of the battery. The flash 160 emits light from a xenon tube by using the charge stored in the capacitor according to a command from the controller 130.

### 2. Operation

### 2-1. Imaging Operation of Digital Camera 100

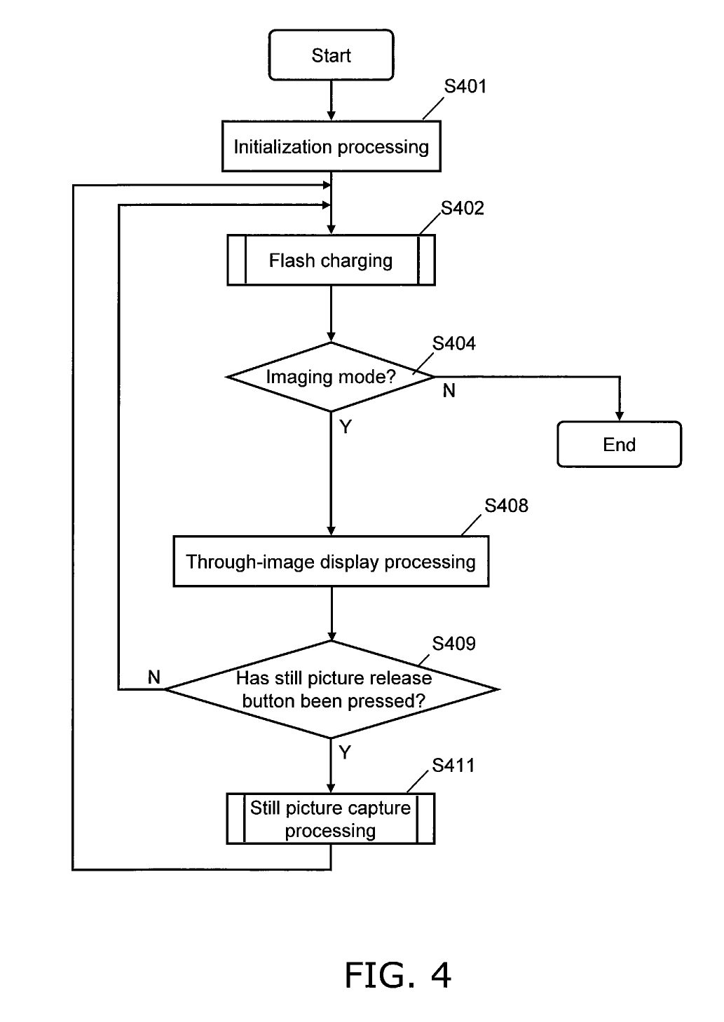

The imaging control of the digital camera 100 will be described in the following. The digital camera 100 executes processing that assigns capture time and imaging information with respect to captured image data, and records this image data. FIG. 4 is a flowchart of imaging control when the digital camera 100 is in imaging mode. The digital camera 100 can capture both moving pictures and still pictures in imaging mode. The capture of a still picture will be described here as an example of capture in imaging mode.

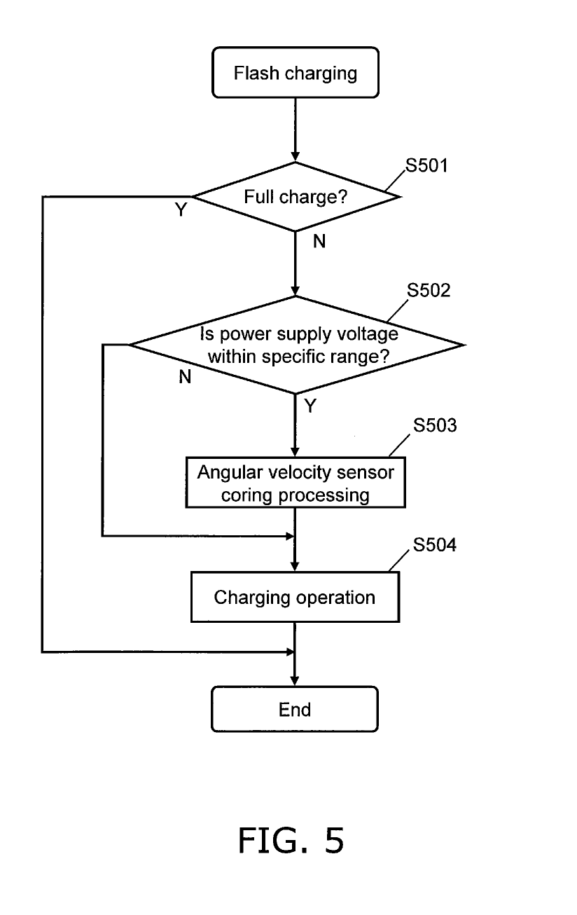

When the digital camera 100 has been put in imaging mode by operation of the mode switch 207 by the user, the controller 130 performs initialization processing required for still picture recording (S401). When the initialization processing is finished, the charging controller 132 acquires the charging voltage of the flash 160 and the voltage of the battery 125. The charging controller 132 then changes the flash on the basis of the charging voltage of the flash 160 and/or the voltage of the battery 125 (S402). The charging of the flash will be described in detail below through reference to the flowchart in FIG. 5.

The controller 130 repeats processing to check input by the user and display processing. These include checking the state of the mode switch 207 (S404), displaying a through-image (S408), and monitoring the pressing of the shutter button 201 (S409).

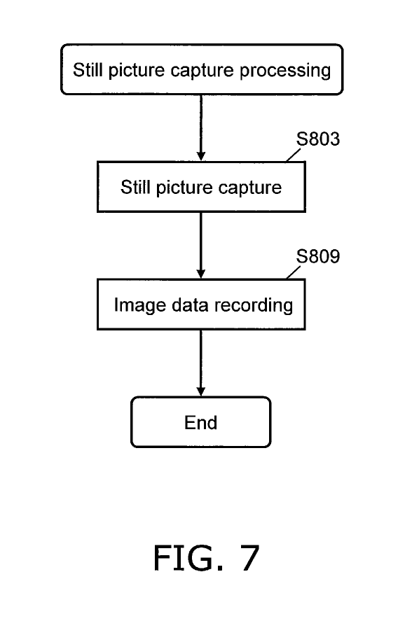

In step 404 (S404), if the state of the mode switch 207 is not imaging mode (No in S404), the processing related to imaging mode is ended. On the other hand, if the state of the mode switch 207 in step 404 is imaging mode (Yes in S404), the controller 130 performs display processing of a through-image according to settings related to display that are currently set (S408). Also, if it is detected in step 409 (S409) that the shutter button 201 has been pressed (Yes in S409), the controller 130 performs still picture imaging processing (S411). This still picture imaging processing will be described in detail below through reference to the flowchart in FIG. 7.

If the pressing of the shutter button 201 has not been detected (No in S409) in step 409 (S409), the controller 130 repeatedly executes the processing from step S402 on. If the still picture imaging processing of step S411 has ended, the controller 130 repeatedly executes the processing form step S402.

FIG. 5 is a flowchart of the flash charging operation. The charging controller 132 acquires the charging voltage value of the flash 160, and stores it in the buffer memory 124. The charging voltage value is the voltage value at both ends of the light emitting capacitor of the flash 160. The charging controller 132 determines whether or not this charging voltage value is at or above a full-charge voltage value stored in the flash memory 142 (S501). If the charging voltage value is at or above the full-charge voltage value (Yes in S501), the charging controller 132 does not charge the flash 160.

If the charging voltage value of the flash 160 is less than the full-charge voltage value (No in S501), the charging controller 132 acquires the power supply voltage value of the battery 125 and stores it in the buffer memory 124. The charging controller 132 then determines whether or not the power supply voltage value of the battery 125 is within a specific voltage range stored in the flash memory 142 (S502).

If the power supply voltage value of the battery 125 is outside the specific voltage range (No in S502), the charging controller 132 charges the flash 160 without performing angular velocity sensor coring processing (S504). In the charging operation, the charging controller 132 boosts the voltage from the battery 125 and supplies it to the light emitting capacitor of the flash 160. The charging controller 132 then changes until the charging voltage value of the light emitting capacitor of the flash 160 reaches the full-charge voltage value stored in the flash memory 142.

On the other hand, if the power supply voltage value of the battery 125 is within the specific voltage range (Yes in S502), the blur correction controller 131 performs the angular velocity sensor coring processing (S503). In this angular velocity sensor coring processing, the blur correction controller 131 stores the output signal of the angular velocity sensor 170 in the buffer memory 124, and subtracts a specific voltage value stored in the flash memory 142 from the voltage value corresponding to the output signal of the angular velocity sensor 170. Executing angular velocity sensor coring processing thus lowers the angular velocity sensor output signal level for blur correction.

The reason for performing angular velocity sensor coring processing will now be explained. To charge the capacitor used for light emission in the flash 160, the power supply voltage of the battery 125 must be boosted to the full-charge voltage of the capacitor. To boost the power supply voltage, a FET (Field Effect Transistor) 165 for booster control is connected to the booster transformer 160a. The FET 165 for booster control is driven at a frequency corresponding to the power supply voltage of the battery 125, and as a result the full-charge voltage is outputted from the booster transformer 160a (secondary side of the booster transformer 160a). The booster transformer 160a and the FET 165 for booster control are examples of a transformer circuit.

At this point, if the frequency at which the charging controller 132 drives the FET 165 for booster control is an integer multiple of the drive frequency of the angular velocity sensor 170, an angular velocity that does not correspond to the actual orientation change in the camera (that is, noise) may end up being outputted. If this noise is outputted, the blur correction controller 131 determines that this noise is the angular velocity produced by a change in the camera orientation. Therefore, even though there is no blur (the camera is still), the blur correction controller 131 drives the OIS lens 115. That is, a blurred image is incident on the CCD image sensor 120 despite the fact that the camera is in a still state. Thus, unneeded correction may be performed if the frequency at which the charging controller 132 drives the FET 165 for booster control is an integer multiple of the drive frequency of the angular velocity sensor 170.

In view of this, angular velocity sensor coring processing is executed when the above-mentioned noise is generated. This angular velocity sensor coring processing is processing that lowers the angular velocity sensor output signal level by an amount equivalent to the noise. This processing is executed by the blur correction controller 131. This processing reduces unnecessary correction caused by noise during flash charging.

Noise in the output of the angular velocity sensor 170 can be identified by measuring the frequency at which the FET 165, for booster control, is driven. Also, since the power supply voltage of the battery 125 corresponds to this frequency; the presence of noise in the output of the angular velocity sensor 170 can also be identified by measuring the power supply voltage of the battery 125.

Here, the blur correction controller 131 measures the power supply voltage of the battery 125, which is easy to measure, and determines whether or not there is noise in the output of the angular velocity sensor 170. If there is noise, angular velocity sensor coring processing (processing to cancel out the noise in the angular velocity sensor during flash charging) is executed. Thus having the blur correction controller 131 identify a situation in which noise occurs and execute angular velocity sensor coring processing diminishes unnecessary correction that occurs during flash charging.

When the above-mentioned angular velocity sensor coring processing is executed (S504), the charging controller 132 charges the flash 160 (S504).

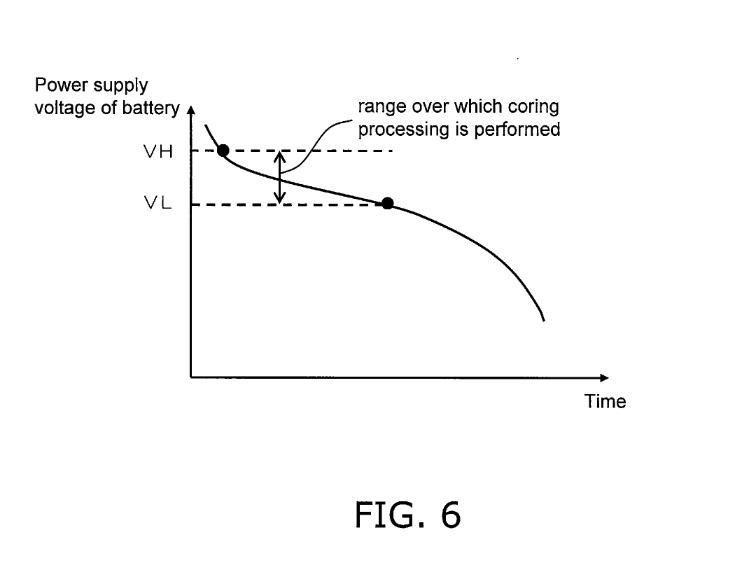

FIG. 6 is a diagram illustrating the range over which angular velocity sensor coring processing is performed, and the power supply voltage value of the battery 125. FIG. 6 shows the state when the remaining battery charge decreases and the power supply voltage value of the battery is reduced as the usage time (shown on the horizontal axis) increases. In the state in FIG. 6, angular velocity sensor coring processing is executed if the power supply voltage value of the battery is within a specific voltage range (within a range of VL to VH, including VL and VH in FIG. 6). On the other hand, angular velocity sensor coring processing is not executed if the power supply voltage value of the battery is outside the specific voltage range (outside the range of VL to VH in the drawing).

FIG. 7 is a flowchart of still picture capture processing. When the pressing of the shutter button 201 by the user is detected, the controller 130 temporarily stores a still picture produced by the image processor 122 as image data in the buffer memory 124 on the basis of the image data produced by the CCD image sensor 120 (S803). Next, the controller 130 records this image data to the memory card 140 or another such recording medium (S809), and ends capture processing.

### 3. Conclusion

As discussed above, the digital camera 100 in this embodiment comprises the CCD image sensor 120, a transformer circuit (the booster transformer 160a and the FET 165 for booster control) for emitting light from the flash 160, the charging controller 132, the angular velocity sensor 170, the flash memory 142, and the blur correction controller 131. The CCD image sensor 120 captures a subject and outputs image data. The transformer circuit is used to transform power supply voltage. The charging controller 132 controls the transformer circuit. The angular velocity sensor 170 detects blur in the image data. The flash memory 142 stores information related to a specific frequency range, such as information related to a specific power supply voltage range. The blur correction controller 131 performs blur correction control on the basis of the output of the angular velocity sensor 170 when the power supply voltage is outside a specific range of power supply voltage (when the frequency of the transformer circuit is outside a specific frequency range) while the charging controller 132 is performing control. The blur correction controller 131 performs blur correction control along with angular velocity sensor coring processing when the power supply voltage is within a specific range of power supply voltage (when the frequency of the transformer circuit is within a specific frequency range) while the circuit controller 132 is performing control.

With this configuration, the blur correction controller 131 identifies a situation in which noise is generated, and angular velocity sensor coring processing is performed to cancel out the noise in the angular velocity sensor during flash charging, which means that unnecessary correction that occurs during flash charging can be reduced.

### 4. Other Embodiments

The present invention is not limited to or by the above embodiment, and various embodiments are possible. Other embodiments of the present invention will be discussed below.

(A) In the above embodiment, an example was given in which the charging controller 132, which performs angular velocity sensor coring processing, determined whether or not the power supply voltage value of the battery 125 was within a specific voltage range held in the flash memory 142. This specific voltage range is set by pre-measuring the power supply voltage value when the angular velocity sensor outputs noise, and storing this in the flash memory 142 for later use.

On the other hand, the specific voltage range may be set by measuring the voltage range during the use of the digital camera 100. For instance, first whether or not the digital camera 100 is in a still state is determined. Whether or not it is in a still state is determined by whether or not the time period in which the output of the angular velocity sensor 170 is at or below a certain level (an example of a second threshold value) in a state in which the flash 142 is not being charged has continued for a certain length of time or longer. If the result of this determination is that the digital camera 100 is in a still state, then charging of the flash 142 is executed. This processing can be executed after use of the flash memory 142 or in a certain mode (test mode) for setting a particular range, for example.

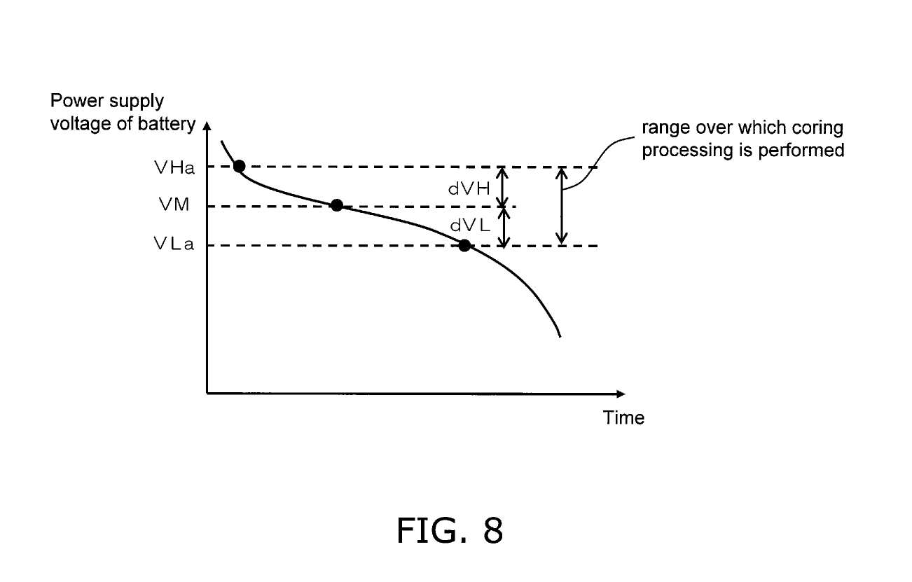

If there is a sharp increase in the output of the angular velocity sensor 170 during the above-mentioned charging operation, such as when the output of the angular velocity sensor rises to or above a certain threshold (an example of a first threshold value), this output is assumed to be noise. Therefore, the power supply voltage of the battery 125 at this point is measured and recorded to the flash memory 142. For example, in FIG. 8, the power supply voltage corresponding to noise corresponds to VM. In this case, the specific voltage range is set using this power supply voltage VM as a reference. Here, the upper limit VHa of the specific voltage range is set by adding a specific voltage value dVH to the power supply voltage VM. Also, the lower limit VLa of the specific voltage range is set by subtracting a specific voltage value dVL from the power supply voltage VM. Thus, angular velocity sensor coring processing can be performed just as above by setting a specific voltage range.

This measurement operation can be performed as needed, whenever the digital camera 100 is determined to be in a still state.

(B) In the above embodiment, an example was given in which control was performed using one certain specific voltage range. Instead, control that takes temperature characteristics into account may be executed. In this case, for example, the voltage range when the angular velocity sensor 170 outputs noise is pre-measured in different temperature environments. The voltage range and the temperatures of the various environments are recorded to the flash memory 142. In step S502 in FIG. 5, first the temperature near the angular velocity sensor 170 is measured by a temperature sensor (not shown), and the voltage range corresponding to this temperature is read from the flash memory 142. Consequently, a more suitable voltage range can be set according to the temperature characteristics, so malfunction in blur correction control can be further reduced.

### INDUSTRIAL APPLICABILITY

The present invention provides an imaging device with which accuracy of blur correction during flash charging can be improved. The present invention can also be applied to digital still cameras, video cameras, portable telephones, smart phones, and the like that are equipped with a flash and a blur detecting function.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the imaging device equipped with the lens barrel. Accordingly, these terms, as utilized to describe the technology disclosed herein should be interpreted relative to the imaging device equipped with the lens barrel.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device comprising:
an imaging component configured to capture a subject and output image data;
a transformer circuit configured to transform a power supply voltage;
a control circuit configured to control the transformer circuit;
a blur detecting sensor configured to detect blur in the image data;
a memory configured to store information related to a specific frequency range; and
a blur correction controller configured to:
perform a first blur correction control based on the output of the blur detecting sensor if the frequency of the transformer circuit is outside the specific frequency range, and
perform a second blur correction control that is different from the first blur correction control if the frequency of the transformer circuit is within the specific frequency range.

2. The imaging device according to claim 1, wherein:
the second blur correction control corrects the frequency of the transformer circuit.

3. The imaging device according to claim 1, wherein:
the power supply voltage corresponds to the frequency of the transformer circuit;
the memory stores information related to a specific voltage range; and
the blur correction controller performs the first blur correction control if the power supply voltage is outside the specific voltage range while the control circuit is performing control, and performs the second blur correction control if the power supply voltage is within the specific voltage range.

4. The imaging device according to claim 3, wherein:
the second blur correction control lowers the output of the blur detecting sensor by subtracting a specific voltage value stored in the memory from a voltage value corresponding to the output of the blur detecting sensor.

5. The imaging device according to claim 1, further comprising:
a noise detector configured to:
set the specific frequency range based on the frequency of the transformer circuit if the output of the blur detecting sensor is at or above a first threshold value while the control circuit is performing control, and
store information related to the specific frequency range in the memory.

6. The imaging device according to claim 5, wherein:
the noise detector is further configured to direct the control circuit to start control if the output of the blur detecting sensor is at or below a second threshold value during a specific time period.

7. The imaging device according to claim 1, wherein:
the transformer circuit is further configured to transform the power supply voltage in order to charge a flash.

8. The imaging device according to claim 1, further comprising:
a temperature sensor configured to read and output a temperature data of the environment of the imaging device; and wherein
the memory is further configured to store the temperature data; and
the blur correction controller adjusts the specific frequency range depending upon the temperature data.

9. A method wherein:
an imaging component captures a subject and output image data;
a transformer circuit transforms a power supply voltage;
a control circuit controls the transformer circuit;
a blur detecting sensor detects blur in the image data;
a memory stores information related to a specific frequency range; and
a blur correction controller performs:
a first blur correction control based on the output of the blur detecting sensor if the frequency of the transformer circuit is outside the specific frequency range, and
a second blur correction control that is different from the first blur correction control if the frequency of the transformer circuit is within the specific frequency range.

10. The method according to claim 9, further wherein:
the second blur correction control corrects the frequency of the transformer circuit.

11. The method according to claim 9, further wherein:
the power supply voltage corresponds to the frequency of the transformer circuit;
the memory stores information related to a specific voltage range; and
the blur correction controller performs the first blur correction control if the power supply voltage is outside the specific voltage range while the control circuit is performing control, and performs the second blur correction control if the power supply voltage is within the specific voltage range.

12. The method according to claim 11, further wherein:
the second blur correction control lowers the output of the blur detecting sensor by subtracting a specific voltage value stored in the memory from a voltage value corresponding to the output of the blur detecting sensor.

13. The method according to claim 9, further wherein:
a noise detector:
sets the specific frequency range based on the frequency of the transformer circuit if the output of the blur detecting sensor is at or above a first threshold value while the control circuit is performing control, and
stores information related to the specific frequency range in the memory.

14. The imaging device according to claim 13, further wherein:
the noise detector directs the control circuit to start control if the output of the blur detecting sensor is at or below a second threshold value during a specific time period.

15. The method according to claim 9, further wherein:
the transformer circuit transforms the power supply voltage in order to charge a flash.

16. The method according to claim 10, further wherein:
a temperature sensor reads and outputs a temperature data of the environment of the imaging device;
the memory is further configured to store the temperature data; and
the blur correction controller adjusts the specific frequency range depending upon the temperature data.
